(19) United States
(12) Patent Application Publication
(10) Pub. No.: US 2024/0335847 A1
(43) Pub. Date: Oct. 10, 2024

(54) BLADDERS FOR INCORPORATION INTO GARMENTS, AND METHODS OF ASSEMBLING AND USING THE SAME

(71) Applicant: Jeff P. Shaffer, Columbia City, IN (US)

(72) Inventor: Jeff P. Shaffer, Columbia City, IN (US)

(21) Appl. No.: 18/632,005

(22) Filed: Apr. 10, 2024

Related U.S. Application Data
(60) Provisional application No. 63/577,223, filed on Apr. 10, 2023.

(51) Int. Cl. B05B 9/00; A41D 27/00

(52) U.S. Cl. CPC B05B 9/00; A41D 27/00

(57) ABSTRACT

Articles of clothing (garments) that incorporate a bladder adapted to eject a fluid through the garment. Such a bladder includes front and back sides formed by walls that define therebetween an interior cavity within the bladder. A nozzle assembly is disposed in the front side of the bladder so that a fluid within the cavity can be ejected from the bladder by compressing the bladder. The nozzle assembly includes a fitting, a nozzle, and an adapter. Each of the fitting, nozzle, and adapter has an internal passage disposed within respective tubular portions and flanges of the fitting, nozzle, and adapter. The nozzle assembly is assemblable by inserting the tubular portion of the adapter into the internal passage of the fitting and inserting the tubular portion of the nozzle in the internal passage of the adapter. The flanges of the fitting and adapter are adapted to sandwich the garment therebetween.

### CROSS-REFERENCE TO RELATED APPLICATIONS

This application claims the benefit of U.S. Provisional Application No. 63/577,223, filed Apr. 10, 2023, the contents of which are incorporated herein by reference.

### BACKGROUND OF THE INVENTION

The present invention generally relates to articles of clothing and more particularly to an article of clothing that incorporates a bladder disposed on the article so as not to be visible when the article is worn. The bladder has an interior cavity adapted to contain a fluid and includes a nozzle through which the fluid can be ejected from the bladder by compressing the bladder, the nozzle being oriented with respect to the article such that the fluid is ejected in a direction outwardly and away from the article.

### BRIEF SUMMARY OF THE INVENTION

The intent of this section of the specification is to briefly indicate the nature and substance of the invention, as opposed to an exhaustive statement of all subject matter and aspects of the invention. Therefore, while this section identifies subject matter recited in the claims, additional subject matter and aspects relating to the invention are set forth in other sections of the specification, particularly the detailed description, as well as any drawings.

The present invention provides, but is not limited to, an article of clothing (garment) that incorporates a bladder adapted to eject a fluid from the bladder through the garment in a direction outwardly and away from the garment.

According to a nonlimiting aspect of the invention, a bladder includes walls that define a front side and a back side of the bladder and further define therebetween an interior cavity within the bladder. The bladder is fluid-tight so as to be adapted to contain a fluid within the interior cavity. A nozzle assembly is disposed in the front side of the bladder so that the fluid within the interior cavity can be ejected from the bladder by compressing the bladder. The nozzle assembly includes at least a fitting, a nozzle, and an adapter between the fitting and the nozzle. Each of the fitting, the nozzle, and the adapter has an internal passage disposed within respective tubular portions and flanges of the fitting, the nozzle, and the adapter. The nozzle assembly is assemblable by inserting the tubular portion of the adapter into the internal passage of the fitting and inserting the tubular portion of the nozzle in the internal passage of the adapter, the flanges of the fitting and the adapter being adapted to sandwich a portion of the garment therebetween.

According to other nonlimiting aspects of the invention, methods are provided for assembling the bladder to a garment and using a garment to eject the fluid from the bladder.

Various aspects and advantages of bladders and methods as described above will be appreciated from the following detailed description as well as any drawings.

### BRIEF DESCRIPTION OF THE DRAWINGS

FIGS. 1 through 3 schematically represent, respectively, a front view, a cross-sectional left side view, and a top view of a bladder adapted to be incorporated into an article of clothing in accordance with a nonlimiting embodiment of this invention.

FIG. 4 schematically represents an article of clothing into which the bladder of FIGS. 1 through 3 has been incorporated in accordance with a nonlimiting embodiment of this invention.

### DETAILED DESCRIPTION OF THE INVENTION

The intended purpose of the following detailed description of the invention and the phraseology and terminology employed therein is to describe what is shown in the drawings, which include the depiction of and/or relate to one or more nonlimiting embodiments of the invention, and to describe certain but not all aspects of what is depicted in the drawings, including embodiment(s) depicted in the drawings. The following detailed description also identifies certain but not all alternatives of the embodiment(s) depicted in the drawings. As nonlimiting examples, the invention encompasses additional or alternative embodiments in which one or more features or aspects shown and/or described as part of a particular embodiment could be eliminated, and also encompasses additional or alternative embodiments that combine two or more features or aspects shown and/or described as part of different embodiments. Therefore, the appended claims, and not the detailed description, are intended to recite what are believed to be aspects of the invention, including certain but not necessarily all of the aspects and alternatives described in the detailed description.

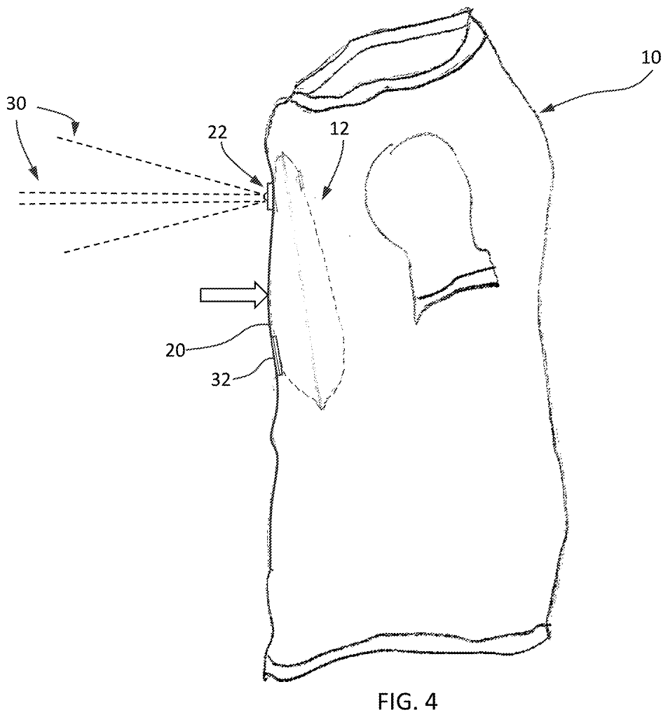

The following disclosure describes various aspects of articles of clothing (hereinafter, garments) 10 equipped with a bladder 12 as schematically represented in FIG. 4 and to methods for using such a garment 10. To facilitate the description provided below of the garment 10 and bladder 12 represented in the drawings, relative terms may be used in reference to the orientation of the garment 10 and bladder 12 as represented in the drawings. All such relative terms are intended to indicate the construction and relative orientations of components and features of the invention, and therefore are relative terms that are useful to describe the illustrated embodiments but should not be otherwise interpreted as limiting the scope of the invention.

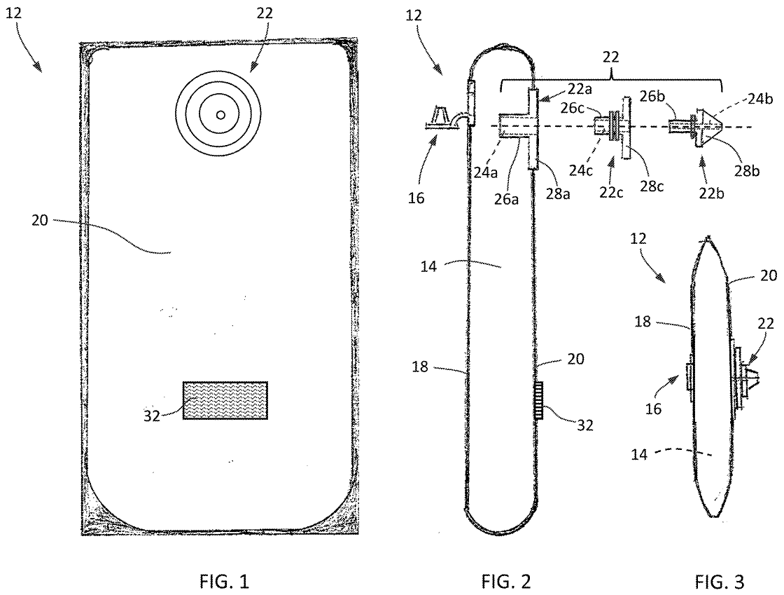

FIGS. 1 through 3 schematically represent a bladder 12 adapted to be incorporated into a garment 10, such as a shirt shown in FIG. 4. As represented in FIG. 4, the garment 10 preferably (though not necessarily) incorporates the bladder 12 such that the bladder 12 is disposed on an interior side of the garment 10 so as not to be visible when the garment 10 is worn.

The bladder 12 is represented in FIGS. 1 through 3 as having an interior cavity 14. The bladder 12 is formed of a fluid-tight material, for example, polyurethane, and is adapted to contain a fluid (e.g., water) that can be introduced into the cavity 14 through a closable port 16 disposed on a back side 18 of the bladder 12. As represented, the closable port 16 may comprise a tapered plug and a complementary port opening adapted to receive the plug. Though the bladder 12 is represented as having a generally rectangular peripheral shape when viewed from the back side 18 as well as a front side 20 (FIG. 1) thereof, other shapes are foreseeable. The bladder 12 includes a nozzle assembly 22 through which the fluid can be ejected from the bladder 12 by compressing the bladder 12, for example, by being pressed at the front side 20 of the bladder 12. The nozzle assembly 22 is depicted in FIG. 4 as oriented with respect to the garment 10 such that the fluid is ejected through the nozzle assembly 22 in a direction outwardly and away from the garment 10 when the bladder 12 is compressed.

The nozzle assembly 22 is represented in FIG. 2 as comprising at least three components, referred to herein as a fitting 22a, a nozzle 22b, and an adapter 22c therebetween. Each of the fitting 22a, nozzle 22b, and adapter 22c has an internal passage 24a, 24b, and 24c, respectively, disposed within respective tubular portions 26a, 26b, and 26c of the fitting 22a, nozzle 22b, and adapter 22c. Finally, each of the fitting 22a, nozzle 22b, and adapter 22c has a flange 28a, 28b, and 28c, respectively, disposed at a front side of its corresponding tubular portion 26a, 26b, and 26c. The nozzle assembly 22 can be obtained by assembling the fitting 22a, nozzle 22b, and adapter 22c in a manner represented in FIG. 2, in which the passage 24a of the fitting 22a is sized to receive the tubular portion 26c of the adapter 22c with an interference fit, and the passage 24c of the adapter 22c is sized to receive the tubular portion 26b of the nozzle 22b with an interference fit. The tubular portions 26b and 26c of the nozzle 22b and adapter 22c are represented as having one or more ribs to promote an interference fit and a fluid-tight seal between the fitting 22a, nozzle 22b, and adapter 22c. As evident from FIG. 3, in the absence of the garment 10, assembling the nozzle assembly 22 results in the flange 28c of the adapter 22c abutting and being sandwiched between the flanges 28a and 28b of the fitting 22a and nozzle 22b. In this arrangement, progressively decreasing diameters of the passages 24a, 24c, and 24b of the fitting 22a, adapter 22c, and nozzle 22b cause the fluid within the bladder 12 to accelerate as it exits the cavity 14 before exiting through the smallest cross-sectional area defined by the passage 24b of the nozzle 22b.

The fitting 22a is represented as permanently incorporated into a front wall of the bladder 12 that defines the front side 20 of the bladder 12, for example, as a result of bonding the fitting 22a within an opening in the front wall of the bladder 12, optionally including sandwiching the flange 28a of the fitting 22a between layers that form the front wall of the bladder 12. Alternatively, the fitting 22a could be a multi-component assembly by which the front wall of the bladder 12 is sandwiched between flanges of two separate components of the fitting 22a. The bladder 12 and its nozzle assembly 22 can be incorporated into an article of clothing, such as the garment 10 of FIG. 4, by providing a hole in the garment 10 where the nozzle assembly 22 is desired. Attachment of the bladder 12 to the garment 10 can be through various means and methods. As a nonlimiting example, the bladder 12 may be positioned within the garment 10 without the nozzle 22b and adapter 22c coupled to the fitting 22a, and the passage 24a of the fitting 22a is then aligned within the hole in the garment 10 after which the tubular portion 26c of the adapter 22c can be inserted into the passage 24a of the fitting 22a so that the bladder 12 is secured to the garment 10 as a result of a portion of the garment 10 being captured and sandwiched between the flanges 28a and 28c of the fitting 22a and adapter 22c. The hole in the garment 10 may be a preformed feature of the garment 10, or the user may form the hole in the garment 10 prior to assembly of the bladder 12 or during the installation of the bladder 12, for example, by forming the tubular portion 26c of the adapter 22c to have a sharp and/or tapered edge capable of piercing the garment 10 during insertion of the tubular portion 26c of the adapter 22c into the passage 24a of the fitting 22a. The tubular portion 26b of the nozzle 22b may be inserted into the passage 24c of the adapter 22c before or after the adapter 22c is assembled with the fitting 22a to complete the nozzle assembly 22. The bladder 12 may be further secured to the garment 10 with complementary hook-and-loop fasteners 32 provided on the garment 10 and bladder 12.

Though a particular arrangement of the fitting 22a, nozzle 22b, and adapter 22c of the nozzle assembly 22 is represented in FIG. 2, it is foreseeable that the fitting 22a, nozzle 22b, and adapter 22c could be configured for assembly by alternative methods. For example, the nozzle 22b could be configured for direct installation into the passage 24a of the fitting 22a and the adapter 22c could be configured to be assembled onto the nozzle 22b to secure the flange 28b of the nozzle 22b (as well as a portion of the garment 10) between the flanges 28a and 28c of the fitting 22a and adapter 22c.

As represented in FIG. 4, in use the front side 20 of the bladder 12 can be pressed through the garment 10 to cause a fluid within the bladder 12 to be ejected as a stream 30 from the nozzle assembly 22. Because the nozzle 22b defines the characteristics of the fluid stream 30, it is foreseeable that multiple nozzles 22b having different internal passages 24b of different diameters and/or cross-sectional shapes could be interchangeably installed in the adapter 22c to alter characteristics of the fluid stream 30 such as the distance it can be ejected and/or the angle that the stream 30 is dispersed, as indicated in FIG. 4.

As previously noted above, though the foregoing detailed description describes certain aspects of one or more particular embodiments of the invention, alternatives could be adopted by one skilled in the art. For example, the bladder 12 and its components could differ in appearance and construction from the embodiment described herein and shown in the drawings, functions of certain components of the bladder 12 could be performed by components of different construction but capable of a similar (though not necessarily equivalent) function, and various materials could be used in the fabrication of the bladder 12 and/or its components. In addition, it is foreseeable that the bladder 12 could be compressed using a battery-powered actuator or the like. As such, and again as was previously noted, it should be understood that the invention is not necessarily limited to any particular embodiment described herein or illustrated in the drawings.

1. A bladder adapted to be incorporated into a garment and eject a fluid from the bladder through the garment, the bladder comprising:
walls defining a front side and a back side of the bladder and defining therebetween an interior cavity within the bladder, the bladder being fluid-tight so as to be adapted to contain a fluid within the interior cavity; and
bladder by compressing the bladder, the nozzle assembly being disposed in the front side of the bladder and comprising at least a fitting, a nozzle, and an adapter between the fitting and the nozzle, each of the fitting, the nozzle, and the adapter having an internal passage disposed within respective tubular portions and flanges of the fitting, the nozzle, and the adapter, the nozzle assembly being assemblable by inserting the tubular portion of the adapter into the internal passage of the fitting and inserting the tubular portion of the nozzle in the internal passage of the adapter, the flanges of the fitting and the adapter being adapted to sandwich a portion of the garment therebetween.

2. The bladder of claim 1, further comprising a closable port disposed on the back side of the bladder through which the fluid can be introduced into the internal cavity.

3. The bladder of claim 1, wherein the fitting is permanently incorporated into one of the walls of the bladder that defines the front side of the bladder by bonding the fitting within an opening in the bladder.

4. A garment incorporating the bladder of claim 1, wherein the bladder is disposed on the garment so as not to be visible when the garment is worn.

5. A method of using the garment of claim 4, the method comprising compressing the front side of the bladder through the garment to cause the fluid within the bladder to be ejected as a stream from the nozzle assembly.

6. The method of claim 5, wherein the nozzle is a first nozzle and the method comprises providing at least a second nozzle that has an internal passage that is different from the internal passage of the first nozzle so as to alter at least one characteristic of the stream of the fluid ejected through the nozzle assembly.

7. The method of claim 5, wherein the internal passage of the second nozzle is different from the internal passage of the first nozzle in diameter and/or cross-sectional shape.

8. A method of incorporating the bladder of claim 1 into the garment, the method comprising:
providing a hole in the garment;
positioning the bladder within the garment so that the internal passage of the fitting is aligned within the hole in the garment; and
inserting the tubular portion of the adapter into the internal passage of the fitting so that the bladder is secured to the garment as a result of a portion of the garment being sandwiched between the flanges of the fitting and the adapter.

9. The method of claim 8, further comprising inserting the tubular portion of the nozzle into the internal passage of the adapter before the adapter is assembled with the fitting.

10. The method of claim 8, further comprising inserting the tubular portion of the nozzle into the internal passage of the adapter after the adapter is assembled with the fitting.
